(19) United States
(12) Patent Application Publication
(10) Pub. No.: US 2026/0267768 A1
(43) Pub. Date: Sep. 10, 2026

(54) SYSTEM FOR EVALUATING PERFORMANCE OF AUTONOMOUS DRIVING AI

(71) Applicant: SoftBank Group Corp., Tokyo (JP)

(72) Inventor: Ryo HANAZAKI, Tokyo (JP)

(21) Appl. No.: 19/558,440

(22) Filed: Mar. 6, 2026

Related U.S. Application Data
(60) Provisional application No. 63/769,191, filed on Mar. 10, 2025.

(51) Int. Cl. G06F 11/34; G06F 11/3668; G06F 11/3698; G06F 40/279; G06V 40/20

(52) U.S. Cl. CPC G06F 11/3457; G06F 11/3684; G06F 11/3698; G06F 40/279; G06V 40/23

(57) ABSTRACT

A system that executes highly realistic and diverse simulations by generating virtual vehicles, humans, and environments from natural language and video data using generative AI and inputting them into a digital twin. A generative AI unit analyzes data by making full use of natural language processing technology and computer vision technology, and sets parameters of a virtual environment. A digital twin unit reproduces the physical characteristics of the real world using a physics engine, and a simulation control unit evaluates various scenarios using an autonomous driving AI.

### CROSS-REFERENCE TO RELATED APPLICATIONS

This application is based upon and claims the benefit of priority from U.S. Provisional Patent Application No. 63/769191, filed on Mar. 10, 2025, the entire contents of which are incorporated herein by reference.

### BACKGROUND

Japanese Unexamined Patent Application Publication No. 2022-180282 discloses a method, which is a persona chatbot control method performed by at least one processor, the method including a step of receiving a user utterance, a step of adding the user utterance to a prompt including an instruction sentence associated with a description regarding a character of a chatbot, a step of encoding the prompt, and a step of inputting the encoded prompt to a language model to generate a chatbot utterance responding to the user utterance.

### SUMMARY

A problem to be solved by this disclosure is to improve the efficiency and safety of testing in the development of autonomous driving technology. Conventional testing of autonomous vehicles needs to be conducted on actual roads, which requires a significant amount of time and cost. In addition, testing in the real world has a problem in that it is difficult to sufficiently evaluate responses to unpredictable situations and dangerous scenarios. Furthermore, there is also a problem of a lack of test coverage because only limited scenarios can be reproduced.

A variety of scenarios close to the real world may be reproduced within a virtual environment by generating virtual vehicles, humans, and environments using generative AI and inputting them into a digital twin. As a result, the autonomous driving AI is extensively and thoroughly tested against a variety of situations that may be encountered in the real world, such as different weather conditions, traffic volumes, and road conditions. This makes it possible to take measures for a greater number of scenarios and to improve the safety and reliability of autonomous vehicles.

In addition, testing in a virtual environment does not require physical vehicles or personnel and can be conducted efficiently and economically, making it possible to significantly reduce the time and cost required for testing. This makes it possible to accelerate the development process of autonomous driving technology and bring it to market more quickly. In this way, the spread of autonomous driving technology contributes to the improvement of traffic safety.

Disclosed herein is a system including a generative AI unit, a digital twin unit, and a simulation control unit. The generative AI unit has a function of analyzing input natural language data and video data using natural language processing technology and computer vision technology to generate virtual vehicles, humans, and environments. This generative AI unit makes it possible to virtually construct various scenarios encountered in the real world.

The digital twin unit inputs the virtual objects generated by the generative AI unit and constructs a virtual environment that faithfully reproduces the physical characteristics and behavior of the real world. This digital twin unit enables simulations based on the physical laws of the real world, and can reproduce vehicle behavior and environmental changes in detail.

The simulation control unit executes simulations of various scenarios using an autonomous driving AI in the digital twin unit, and evaluates the performance of the autonomous driving AI for each scenario. By this simulation control unit, the autonomous driving AI is extensively and thoroughly tested against a variety of situations that may be encountered in the real world, such as different weather conditions, traffic volumes, and road conditions.

With these configurations, the efficiency and safety of testing in the development of autonomous driving technology may be improved, to significantly reduce the time and cost required for testing. This can promote the spread of autonomous driving technology and contribute to the improvement of traffic safety.

### BRIEF DESCRIPTION OF THE DRAWINGS

FIG. 1 is a conceptual diagram illustrating an example of a configuration of a data processing system according to a first embodiment.

FIG. 2 is a conceptual diagram illustrating an example of main functions of a data processing apparatus and a smart device according to the first embodiment.

FIG. 3 is a conceptual diagram illustrating an example of a configuration of a data processing system according to a second embodiment.

FIG. 4 is a conceptual diagram illustrating an example of main functions of a data processing apparatus and smart glasses according to the second embodiment.

FIG. 5 is a conceptual diagram illustrating an example of a configuration of a data processing system according to a third embodiment.

FIG. 6 is a conceptual diagram illustrating an example of main functions of a data processing apparatus and a headset-type terminal according to the third embodiment.

FIG. 7 is a conceptual diagram illustrating an example of a configuration of a data processing system according to a fourth embodiment.

FIG. 8 is a conceptual diagram illustrating an example of main functions of a data processing apparatus and a robot according to the fourth embodiment.

FIG. 9 illustrates an emotion map on which a plurality of emotions are mapped.

FIG. 10 illustrates an emotion map on which a plurality of emotions are mapped.

FIG. 11 is a flowchart illustrating an example method of evaluating the performance of an autonomous driving AI

### DETAILED DESCRIPTION

Hereinafter, example systems according to the technology of the present disclosure will be described with reference to the accompanying drawings.

First, terms used in the following description will be described.

In the following embodiments, a processor with a reference sign (hereinafter, simply referred to as a “processor”) may be one arithmetic device or may be a combination of a plurality of arithmetic devices. Also, the processor may be one type of arithmetic device or may be a combination of a plurality of types of arithmetic devices. Examples of the arithmetic device include a CPU (Central Processing Unit), a GPU (Graphics Processing Unit), a GPGPU (General-Purpose computing on Graphics Processing Units), an APU (Accelerated Processing Unit), and the like.

In the following embodiments, a RAM (Random Access Memory) with a reference sign is a memory in which information is temporarily stored, and is used as a work memory by a processor.

In the following embodiments, a storage with a reference sign is one or more non-volatile storage devices that store various programs, various parameters, and the like. Examples of the non-volatile storage device include a flash memory (SSD (Solid State Drive)), a magnetic disk (for example, a hard disk), or a magnetic tape, and the like.

In the following embodiments, a communication I/F (Interface) with a reference sign is an interface including a communication processor, an antenna, and the like. The communication I/F manages communication among a plurality of computers. An example of a communication standard applied to the communication I/F includes a wireless communication standard including 5G (5 th Generation Mobile Communication System), Wi-Fi (registered trademark), or Bluetooth (registered trademark), and the like.

In the following embodiments, “A and/or B” is synonymous with “at least one of A and B”. That is, “A and/or B” means that it may be only A, may be only B, or may be a combination of A and B. Also, in the present specification, when three or more matters are expressed by being connected with “and/or”, the same concept as “A and/or B” is applied.

### First Embodiment

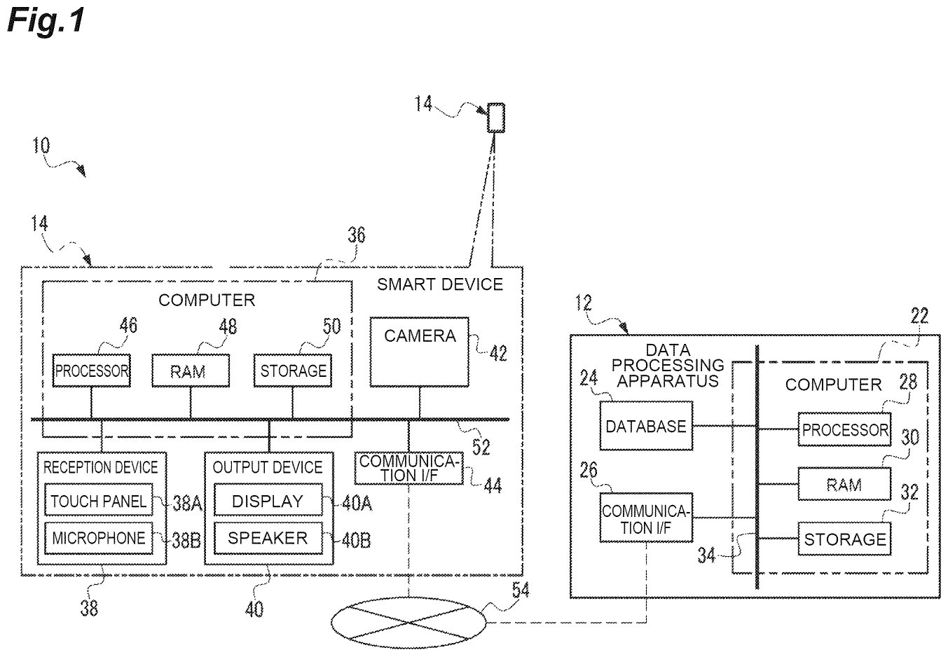

FIG. 1 illustrates an example of a configuration of a data processing system 10 according to a first embodiment.

As illustrated in FIG. 1, the data processing system 10 includes a data processing apparatus 12 and a smart device 14. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The smart device 14 includes a computer 36, a reception device 38, an output device 40, a camera 42, and a communication I/F 44. The computer 36 includes a processor 46, a RAM 48, and a storage 50. The processor 46, the RAM 48, and the storage 50 are connected to a bus 52. Also, the reception device 38, the output device 40, and the camera 42 are also connected to the bus 52.

The reception device 38 includes a touch panel 38A, a microphone 38B, and the like, and receives a user input. The touch panel 38A receives a user input by contact of an indicator by detecting contact of the indicator (for example, a pen or a finger, etc.). The microphone 38B receives a user input by voice by detecting a user's voice. A control unit 46A transmits data indicating the user input received by the touch panel 38A and the microphone 38B to the data processing apparatus 12. In the data processing apparatus 12, a specific processing unit 290 acquires the data indicating the user input.

The output device 40 includes a display 40A, a speaker 40B, and the like, and presents data to a user 20 by outputting the data in a form perceivable by the user 20 (for example, voice and/or text). The display 40A displays visible information such as text and images in accordance with an instruction from the processor 46. The speaker 40B outputs voice in accordance with an instruction from the processor 46. The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted.

The communication I/F 44 is connected to the network 54. The communication I/Fs 44 and 26 manage exchange of various information between the processor 46 and the processor 28 via the network 54.

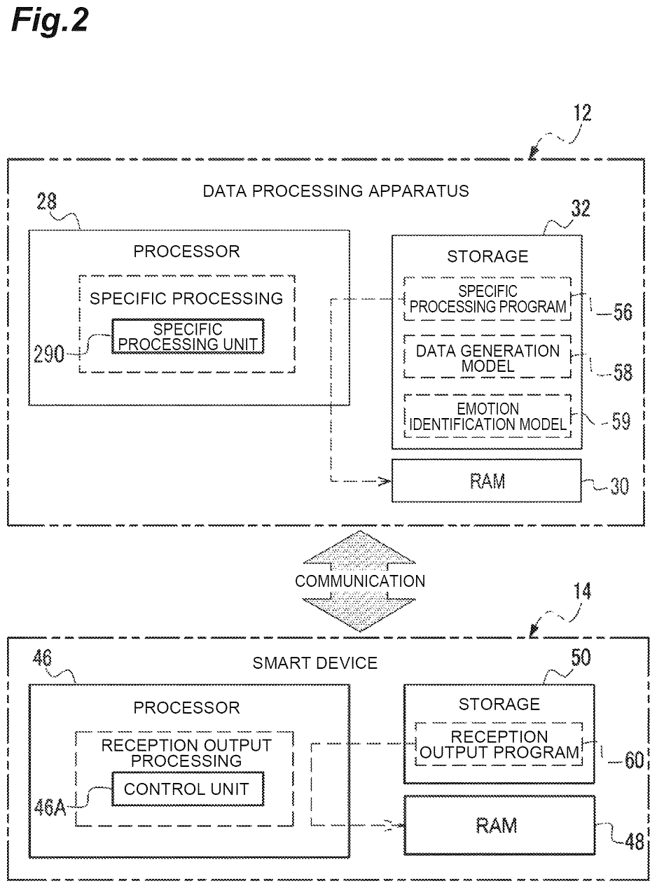

FIG. 2 illustrates an example of main functions of the data processing apparatus 12 and the smart device 14.

As illustrated in FIG. 2, in the data processing apparatus 12, specific processing is performed by the processor 28. A specific processing program 56 is stored in the storage 32. The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290. The specific processing unit 290 can estimate a user's emotion using the emotion identification model 59 and perform specific processing using the user's emotion. In an emotion estimation function (emotion identification function) using the emotion identification model 59, various estimations and predictions regarding the user's emotion, including estimation and prediction of the user's emotion, are performed, but is not limited to such examples. Also, the estimation and prediction of emotion include, for example, analysis (analytics) of emotion and the like.

In the smart device 14, reception output processing is performed by the processor 46. A reception output program 60 is stored in the storage 50. The reception output program 60 is used in combination with the specific processing program 56 by the data processing system 10. The processor 46 reads the reception output program 60 from the storage 50 and executes the read reception output program 60 on the RAM 48. The specific processing is realized by the processor 46 operating as a control unit 46A in accordance with the reception output program 60 executed on the RAM 48. Note that the smart device 14 may have a data generation model and an emotion identification model similar to the data generation model 58 and the emotion identification model 59, and can also perform processing similar to that of the specific processing unit 290 using these models. The reception output processing is realized by the processor 46 operating as the control unit 46A in accordance with the reception output program 60 executed on the RAM 48.

Note that an apparatus other than the data processing apparatus 12 may have the data generation model 58. For example, a server apparatus (for example, a generation server) may have the data generation model 58. In this case, the data processing apparatus 12 obtains a processing result (such as a prediction result) in which the data generation model 58 is used, by communicating with the server apparatus having the data generation model 58. Also, the data processing apparatus 12 may be a server apparatus, or may be a terminal device owned by a user (for example, a mobile phone, a robot, a home appliance, etc.). Next, an example of processing by the data processing system 10 according to the first embodiment will be described.

### Example 1.1

A flow of specific processing in Example 1.1 will be described. Each unit of the system described below is realized by the data processing apparatus 12 and the smart device 14. Also, the data processing apparatus 12 is referred to as a “server”, and the smart device 14 is referred to as a “terminal”.

A system configuration using a server and a terminal will be described in more detail.

First, the generative AI unit is realized on a high-performance server. This server is provided with high computational capability for processing a large amount of data at high speed. The generative AI unit may be configured by, for example, the computer 22 (such as the processor 28) of the data processing apparatus 12, or may be configured by the specific processing unit 290, the specific processing program 56, the data generation model 58, and the like. The generative AI unit analyzes natural language data input by a user from a terminal, using natural language processing technology. For example, when an instruction such as “a driving scenario in a congested urban area on a rainy day” is given, the generative AI unit extracts keywords such as “rain,” “congestion,” and “urban area,” and sets parameters of a virtual environment based on these. In addition, the generative AI unit analyzes video data uploaded by the user from the terminal, using computer vision technology. For example, when a video capturing the traffic situation at an actual intersection is given, the generative AI unit recognizes the movement of vehicles, the behavior of humans, and the state of traffic lights, and reflects this information in the virtual environment. the generative AI unit is configured by a neural network group including a Large Language Model (LLM) based on a Transformer architecture and a Generative Adversarial Network (GAN) or a Diffusion Model. The generative AI unit tokenizes input natural language data (prompt) and maps the data to a high-dimensional vector space, thereby extracting a semantic meaning of a scenario intended by a user (e.g., “slippery road surface”). Furthermore, the generative AI unit has a parameter conversion module that converts the extracted semantic information into a physical parameter set (e.g., road surface friction coefficient μ, visibility distance, noise addition rate to a LiDAR sensor) interpretable by the digital twin unit. This conversion process is not merely a reading of data, but a technical process of converting an abstract concept of natural language into a specific numerical data structure executable for simulation.

Next, the digital twin unit is also realized on the server. The digital twin unit may be configured by, for example, the computer 22 (such as the processor 28) of the data processing apparatus 12, or may be configured by the specific processing unit 290, the specific processing program 56, the data generation model 58, and the like. This digital twin unit constructs a virtual environment that faithfully reproduces the physical characteristics and behavior of the real world, using the virtual objects generated by the generative AI unit. For example, it simulates the acceleration, braking, and behavior at the time of a collision of a vehicle, using a physics engine. In addition, changes in visibility and slipperiness of the road surface due to weather conditions are also reproduced. For example, it is possible to reproduce a situation in a virtual environment where visibility deteriorates and the road surface becomes slippery on a rainy day. Furthermore, the road layout and traffic signal arrangement of an urban area are also reproduced in the virtual environment and operate based on a scenario specified by the user.

The digital twin unit includes a physics engine that executes rigid body dynamics calculations and fluid dynamics calculations in order to reproduce physical laws of the real world. In particular, environmental data such as “rain” and “fog” generated by the generative AI unit functions not only as visual effects to be drawn but also as a signal processing filter that superimposes physical noise and attenuation in real time on detection data of virtual sensors (camera, LiDAR, radar) mounted on a virtual vehicle. For example, in a rainy weather scenario, a process of stochastically generating and inserting noise points simulating diffuse reflection caused by raindrops into point cloud data of LiDAR is performed. This makes it possible to provide “imperfect sensor input” similar to that of the real world to the autonomous driving AI and verify robustness.

The simulation control unit is realized on both the server and the terminal. The simulation control unit may be configured by, for example, the computer 22 (such as the processor 28) of the data processing apparatus 12 and the computer 36 (such as the processor 46) of the smart device 14. On the server, a simulation using an autonomous driving AI is executed within the virtual environment constructed by the digital twin unit. For example, various situations are reproduced, such as a scenario of avoiding a pedestrian who suddenly runs out on a rainy day, and a response at an intersection where a traffic light is malfunctioning. The autonomous driving AI is required to make appropriate judgments for these scenarios and operate the vehicle safely. The simulation control unit records the behavior of the autonomous driving AI in detail for each scenario and generates data for evaluating performance.

The simulation control unit has a feedback loop function of, when the autonomous driving AI causes an accident or a violation in a specific scenario, automatically generating a plurality of “Adversarial Scenarios” in which parameters of the scenario (e.g., a dash-out speed of a pedestrian, a position of an oncoming vehicle) are finely modified, and performing re-testing. This process is executed using a genetic algorithm or reinforcement learning so as to search for an “edge case” where the autonomous driving AI is most likely to fail. This makes it possible to exhaustively verify scenario variations thousands to tens of thousands of times greater than in a case where a human manually designs scenarios in a short time, realizing a verification density that is impossible to achieve by a human mental process.

On the other hand, on the terminal, an interface is provided for the user to check the simulation results and adjust the scenario as necessary. The user can monitor the progress of the simulation in real time through the terminal and evaluate the behavior of the autonomous driving AI in a specific scenario. For example, the user can visually check the simulation results and analyze in detail the movement of the vehicle and the reaction of pedestrians in a specific scenario. In addition, the user can also input a new scenario and execute the simulation again. This allows the user to evaluate the performance of the autonomous driving AI from multiple perspectives and improve the algorithm as necessary.

In this way, the efficiency and safety of testing in the development of autonomous driving technology may be improved through a system configuration that combines a server and a terminal. Through advanced data analysis and simulation processing on the server, it becomes possible to virtually reproduce various scenarios close to the real world, and to efficiently and economically evaluate the performance of autonomous driving technology through a user interface on the terminal. This makes it possible to accelerate the development process of autonomous driving technology and bring it to market more quickly.

The simulation processing may be executed on a parallel distributed computing environment including a plurality of GPUs (Graphics Processing Units) or TPUs (Tensor Processing Units). Scenario generation by the generative AI unit and physical calculation by the digital twin unit are parallelized by pipeline processing, and data is passed on a shared memory space so as to minimize overhead of memory transfer. For example, generated 3D object data is directly instantiated on a VRAM (Video RAM) and passed to the physics engine without passing through a CPU. This optimization at a hardware level reduces latency in high-definition real-time simulation and enables simulation of a large-scale city model.

### System Configuration

The system includes a generative AI unit, a digital twin unit, a simulation control unit, and a user interface unit. The generative AI unit analyzes natural language data and video data input from a user using natural language processing technology and computer vision technology, and generates virtual vehicles, humans, and environments. For example, when a user inputs a prompt sentence such as “a driving scenario in a congested urban area on a rainy day,” the generative AI unit extracts keywords such as “rain,” “congestion,” and “urban area,” and sets parameters of a virtual environment based on these. In addition, when a user uploads a video capturing an actual traffic situation, the generative AI unit recognizes the movement of vehicles, the behavior of humans, and the state of traffic lights from the video, and reflects this information in the virtual environment. Furthermore, the generative AI unit can generate various scenarios using prompt sentences such as, for example, “driving in a mountainous area on a snowy day,” “driving on a highway at night,” and “driving in fog,” in order to reproduce different weather conditions and traffic volumes.

The digital twin unit constructs a virtual environment that faithfully reproduces the physical characteristics and behavior of the real world, using the virtual objects generated by the generative AI unit. For example, it simulates the acceleration, braking, and behavior at the time of a collision of a vehicle, using a physics engine. In addition, changes in visibility and slipperiness of the road surface due to weather conditions are also reproduced. For example, it is possible to reproduce a situation in a virtual environment where visibility deteriorates and the road surface becomes slippery on a rainy day. Furthermore, the road layout and traffic signal arrangement of an urban area are also reproduced in the virtual environment and operate based on a scenario specified by the user. The digital twin unit is capable of reproducing specific driving situations such as, for example, “a scenario where a pedestrian crosses during a right turn at an intersection,” “a lane change scenario during a traffic jam,” and “a vehicle control scenario on a sharp curve.”

The simulation control unit executes a simulation using an autonomous driving AI within the virtual environment constructed by the digital twin unit, and evaluates the performance of the autonomous driving AI for each scenario. For example, various situations are reproduced, such as a scenario of avoiding a pedestrian who suddenly runs out on a rainy day, and a response at an intersection where a traffic light is malfunctioning. The autonomous driving AI is required to make appropriate judgments for these scenarios and operate the vehicle safely. The simulation control unit records the behavior of the autonomous driving AI in detail for each scenario and generates data for evaluating performance. For example, it sets specific evaluation items such as “vehicle control during sudden braking,” “pedestrian detection at night,” and “maintaining inter-vehicle distance on a highway,” and analyzes the simulation results.

The user interface unit is realized on a terminal and provides an interface for the user to check the simulation results and adjust the scenario as necessary. The user can monitor the progress of the simulation in real time through the terminal and evaluate the behavior of the autonomous driving AI in a specific scenario. For example, the user can visually check the simulation results and analyze in detail the movement of the vehicle and the reaction of pedestrians in a specific scenario. In addition, the user can also input a new scenario and execute the simulation again. This allows the user to evaluate the performance of the autonomous driving AI from multiple perspectives and improve the algorithm as necessary. The user interface unit is provided with specific functions such as, for example, “a scenario selection screen,” “a simulation result dashboard,” and “a slider for parameter adjustment.”

### Implementation Steps

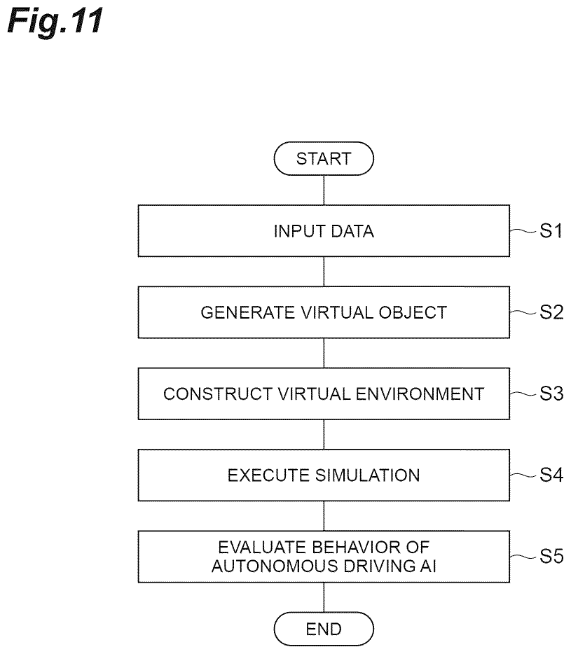

### Step 1: Data Input Step (Refer to Step S1 of FIG. 11)

A user inputs natural language data and video data necessary for a simulation, using a terminal. For example, the user can input a specific prompt sentence such as “a driving scenario in a congested urban area on a rainy day.” In addition, the user can also upload a video capturing an actual traffic situation. In this step, the user provides data for setting various scenarios according to the purpose of the simulation.

### Step 2: Data Analysis Step (Refer to Step S2 of FIG. 11)

The generative AI unit on the server analyzes the input natural language data and video data. Using natural language processing technology, it extracts keywords such as “rain,” “congestion,” and “urban area” from a prompt sentence and sets parameters of a virtual environment. In addition, using computer vision technology, it recognizes the movement of vehicles, the behavior of humans, and the state of traffic lights from video data, and reflects this information in the virtual environment. For example, it can generate various scenarios using prompt sentences such as “driving in a mountainous area on a snowy day,” “driving on a highway at night,” and “driving in fog.”

### Step 3: Virtual Environment Construction Step (Refer to Step S3 of FIG. 11)

The digital twin unit constructs a virtual environment that faithfully reproduces the physical characteristics and behavior of the real world, using the virtual objects generated by the generative AI unit. It simulates the acceleration, braking, and behavior at the time of a collision of a vehicle, using a physics engine. In addition, changes in visibility and slipperiness of the road surface due to weather conditions are also reproduced. For example, it is possible to reproduce a situation in a virtual environment where visibility deteriorates and the road surface becomes slippery on a rainy day. Furthermore, the road layout and traffic signal arrangement of an urban area are also reproduced in the virtual environment.

### Step 4: Simulation Execution Step (Refer to Step S4 of FIG. 11)

The simulation control unit executes a simulation using an autonomous driving AI within the virtual environment constructed by the digital twin unit. For example, various situations are reproduced, such as a scenario of avoiding a pedestrian who suddenly runs out on a rainy day, and a response at an intersection where a traffic light is malfunctioning. The autonomous driving AI is required to make appropriate judgments for these scenarios and operate the vehicle safely. The simulation control unit records the behavior of the autonomous driving AI in detail for each scenario and generates data for evaluating performance.

### Step 5: Result Confirmation and Adjustment Step (Refer to Step S5 of FIG. 11)

Through the user interface unit, the user confirms the simulation results and adjusts the scenario as necessary. The user can monitor the progress of the simulation in real time through the terminal and evaluate the behavior of the autonomous driving AI in a specific scenario. For example, the user can visually check the simulation results and analyze in detail the movement of the vehicle and the reaction of pedestrians in a specific scenario. In addition, the user can also input a new scenario and execute the simulation again. This allows the user to evaluate the performance of the autonomous driving AI from multiple perspectives and improve the algorithm as necessary.

### Specific Use Case

For example, consider a use case of evaluating the performance of an autonomous vehicle. To verify whether the autonomous vehicle can respond to various traffic situations in urban driving, a user sets up a simulation using a terminal. First, the user inputs a prompt sentence “a driving scenario in a congested urban area on a rainy day” into the generative AI unit. Based on this prompt sentence, the generative AI unit extracts keywords such as “rain,” “congestion,” and “urban area,” and sets parameters of a virtual environment based on these.

The generative AI unit analyzes the prompt sentence using natural language processing technology and reflects the road layout and traffic signal arrangement of an urban area, the movement of pedestrians, the flow of vehicles, and the like in the virtual environment. In addition, using computer vision technology, it analyzes an actual traffic situation from video data uploaded by the user and recognizes the movement of vehicles and the state of traffic lights. This makes it possible for the generative AI unit to virtually reproduce various scenarios close to the real world.

Next, the digital twin unit constructs a virtual environment that faithfully reproduces the physical characteristics and behavior of the real world, using the virtual objects generated by the generative AI unit. It simulates the acceleration, braking, and behavior at the time of a collision of a vehicle, using a physics engine, and also reproduces changes in visibility and slipperiness of the road surface due to weather conditions. For example, it is possible to reproduce a situation in a virtual environment where visibility deteriorates and the road surface becomes slippery on a rainy day.

The simulation control unit executes a simulation using an autonomous driving AI within the virtual environment constructed by the digital twin unit. For example, various situations are reproduced, such as a scenario of avoiding a pedestrian who suddenly runs out on a rainy day, and a response at an intersection where a traffic light is malfunctioning. The autonomous driving AI is required to make appropriate judgments for these scenarios and operate the vehicle safely. The simulation control unit records the behavior of the autonomous driving AI in detail for each scenario and generates data for evaluating performance.

Through the user interface unit, the user confirms the simulation results and adjusts the scenario as necessary. The user can monitor the progress of the simulation in real time through the terminal and evaluate the behavior of the autonomous driving AI in a specific scenario. For example, the user can visually check the simulation results and analyze in detail the movement of the vehicle and the reaction of pedestrians in a specific scenario. In addition, the user can also input a new scenario and execute the simulation again. This allows the user to evaluate the performance of the autonomous driving AI from multiple perspectives and improve the algorithm as necessary.

### Example 1.2

A flow of specific processing in Example 1.2 will be described. Each unit of the system described below is realized by the data processing apparatus 12 and the smart device 14. Also, the data processing apparatus 12 is referred to as a “server”, and the smart device 14 is referred to as a “terminal”.

Disclosed herein is a system including a generative AI unit, a digital twin unit, and a simulation control unit, in order to realize a traffic management system in a smart city.

First, the generative AI unit acquires data in real time from various data collection devices installed within a city. This includes traffic sensors, surveillance cameras, GPS devices, and furthermore, mobile applications that accept reports from citizens. The traffic sensors identify the speed, traffic volume, and vehicle type of vehicles on the road, thereby grasping the degree of road congestion in real time. The surveillance cameras provide images of intersections and major roads, and record the flow of vehicles and the movement of pedestrians in detail. The GPS devices provide position information of public transportation and commercial vehicles, thereby making it possible to track the movement lines of vehicles. Furthermore, reports from citizens serve as a valuable source of information for quickly grasping road conditions and the occurrence of traffic accidents.

The generative AI unit integrates these data and analyzes instructions and reports related to traffic using natural language processing technology. For example, it analyzes instructions from a traffic control center and traffic condition reports from citizens, and extracts congestion situations and accident information. In addition, it recognizes the flow of vehicles and the movement of pedestrians from surveillance camera images using computer vision technology. For example, it grasps the congestion situation of vehicles and the flow of pedestrians at a specific intersection in real time, and sets parameters of a virtual environment based on this.

Next, the digital twin unit constructs a virtual environment that reproduces the traffic situation of the entire city, using the virtual objects generated by the generative AI unit. It simulates the movement of vehicles, the control of traffic lights, and the congestion situation of roads, using a physics engine. For example, it is possible to test in a virtual environment the flow of vehicles when a specific road is congested, and the effect of changing the timing of traffic lights. Furthermore, changes in visibility and slipperiness of the road surface due to weather conditions are also reproduced. For example, it is possible to reproduce a situation in a virtual environment where visibility deteriorates and the road surface becomes slippery on a rainy day. In addition, the road layout and traffic signal arrangement of an urban area are also reproduced in the virtual environment and operate based on a scenario specified by the user.

The simulation control unit executes a simulation using a traffic management algorithm within the virtual environment constructed by the digital twin unit. For example, when a specific road is congested, it proposes a detour route and adjusts the timing of traffic lights. In addition, when an emergency vehicle passes, it sets a priority passage route and gives appropriate instructions to other vehicles. This allows the emergency vehicle to quickly reach its destination. Based on the simulation results, it derives an optimal traffic management strategy in real time and reflects it in the actual city traffic. For example, in a traffic control center, it changes the control pattern of traffic lights based on the simulation results and optimizes the flow of traffic. In addition, it provides optimal routes and traffic information to citizens through a smartphone application.

In this way, the traffic efficiency of the entire city may be improved to realize the mitigation of congestion and the reduction of traffic accidents. In addition, it is expected to contribute to the reduction of environmental load and the improvement of convenience for residents. Specific examples of prompt sentences include “Simulate the traffic situation in the city center at 8 a.m. ,” “Propose an optimal route for an emergency vehicle to pass,” and “Adjust the traffic light timing at a specific intersection.” This is expected to make the traffic management of the city more efficient and effective.

### System Configuration

The system includes a generative AI unit, a digital twin unit, and a simulation control unit. The generative AI unit collects data in real time from traffic sensors, surveillance cameras, GPS devices, and mobile applications installed within a city. The traffic sensors identify the speed, traffic volume, and vehicle type of vehicles on the road, thereby grasping the degree of road congestion in real time. For example, sensors installed on major arterial roads and at intersections record the flow of vehicles in detail and identify traffic bottlenecks. In addition, the surveillance cameras provide images of intersections and major roads, and record the flow of vehicles and the movement of pedestrians in detail. For example, it grasps the congestion situation of vehicles and the flow of pedestrians at a specific intersection in real time, and sets parameters of a virtual environment based on this. The GPS devices provide position information of public transportation and commercial vehicles, thereby making it possible to track the movement lines of vehicles. Furthermore, reports from citizens serve as a valuable source of information for quickly grasping road conditions and the occurrence of traffic accidents.

The generative AI unit integrates these data and analyzes instructions and reports related to traffic using natural language processing technology. For example, it analyzes instructions from a traffic control center and traffic condition reports from citizens, and extracts congestion situations and accident information. In addition, it recognizes the flow of vehicles and the movement of pedestrians from surveillance camera images using computer vision technology. This provides basic data for grasping the traffic situation of the entire city in real time and deriving an optimal traffic management strategy. Specific examples of prompt sentences include “Simulate the traffic situation in the city center at 8 a.m. ,” “Propose an optimal route for an emergency vehicle to pass,” and “Adjust the traffic light timing at a specific intersection.”

The digital twin unit constructs a virtual environment that reproduces the traffic situation of the entire city, using the virtual objects generated by the generative AI unit. It simulates the movement of vehicles, the control of traffic lights, and the congestion situation of roads, using a physics engine. For example, it is possible to test in a virtual environment the flow of vehicles when a specific road is congested, and the effect of changing the timing of traffic lights. Furthermore, changes in visibility and slipperiness of the road surface due to weather conditions are also reproduced. For example, it is possible to reproduce a situation in a virtual environment where visibility deteriorates and the road surface becomes slippery on a rainy day. In addition, the road layout and traffic signal arrangement of an urban area are also reproduced in the virtual environment and operate based on a scenario specified by the user.

The simulation control unit executes a simulation using a traffic management algorithm within the virtual environment constructed by the digital twin unit. For example, when a specific road is congested, it proposes a detour route and adjusts the timing of traffic lights. In addition, when an emergency vehicle passes, it sets a priority passage route and gives appropriate instructions to other vehicles. This allows the emergency vehicle to quickly reach its destination. Based on the simulation results, it derives an optimal traffic management strategy in real time and reflects it in the actual city traffic. For example, in a traffic control center, it changes the control pattern of traffic lights based on the simulation results and optimizes the flow of traffic. In addition, it provides optimal routes and traffic information to citizens through a smartphone application.

In this way, the traffic efficiency of the entire city may be improved to realize the mitigation of congestion and the reduction of traffic accidents. In addition, it is expected to contribute to the reduction of environmental load and the improvement of convenience for residents.

### Implementation Steps

### Step 1: Data Collection Step

Data is collected in real time from traffic sensors, surveillance cameras, GPS devices, and mobile applications installed within a city. The traffic sensors identify the speed, traffic volume, and vehicle type of vehicles on the road, and grasp the degree of road congestion. The surveillance cameras provide images of intersections and major roads, and record the flow of vehicles and the movement of pedestrians. The GPS devices provide position information of public transportation and commercial vehicles, and track the movement lines of vehicles. Reports from citizens serve as a source of information for quickly grasping road conditions and the occurrence of traffic accidents.

### Step 2: Data Analysis Step

The generative AI unit integrates the collected data and analyzes instructions and reports related to traffic using natural language processing technology. For example, it analyzes instructions from a traffic control center and traffic condition reports from citizens, and extracts congestion situations and accident information. It recognizes the flow of vehicles and the movement of pedestrians from surveillance camera images using computer vision technology. Specific examples of prompt sentences include “Simulate the traffic situation in the city center at 8 a.m. ,” “Propose an optimal route for an emergency vehicle to pass,” and “Adjust the traffic light timing at a specific intersection.”

### Step 3: Virtual Environment Construction Step

The digital twin unit constructs a virtual environment that reproduces the traffic situation of the entire city, using the virtual objects generated by the generative AI unit. It simulates the movement of vehicles, the control of traffic lights, and the congestion situation of roads, using a physics engine. The flow of vehicles when a specific road is congested and the effect of changing the timing of traffic lights can be tested in the virtual environment. Changes in visibility and slipperiness of the road surface due to weather conditions are also reproduced.

### Step 4: Simulation Execution Step

The simulation control unit executes a simulation using a traffic management algorithm within the virtual environment constructed by the digital twin unit. When a specific road is congested, it proposes a detour route and adjusts the timing of traffic lights. When an emergency vehicle passes, it sets a priority passage route and gives appropriate instructions to other vehicles. Based on the simulation results, it derives an optimal traffic management strategy in real time and reflects it in the actual city traffic.

### Step 5: Result Reflection Step

Based on the simulation results, a traffic control center changes the control pattern of traffic lights and optimizes the flow of traffic. It provides optimal routes and traffic information to citizens through a smartphone application. This makes it possible to improve the traffic efficiency of the entire city and realize the mitigation of congestion and the reduction of traffic accidents.

### Specific Use Case

For example, assume a case where a large-scale event is held in the center of a city. Due to this event, the normal traffic volume increases significantly, and congestion on surrounding roads is expected.

First, traffic sensors and surveillance cameras monitor the road conditions around the event venue in real time and record the flow of vehicles and the movement of pedestrians in detail. GPS devices provide position information of public transportation and commercial vehicles, thereby making it possible to track the movement lines of vehicles. Reports from citizens serve as a source of information for quickly grasping road conditions and the occurrence of traffic accidents.

The generative AI unit integrates these data and analyzes instructions and reports related to traffic using natural language processing technology. For example, it causes the generative AI to read prompt sentences such as “Simulate the traffic situation at the start of the event,” “Propose an optimal detour route after the event ends,” and “Adjust the traffic light timing at a specific intersection.” This extracts congestion situations and accident information, and grasps the traffic situation of the entire city in real time.

Next, the digital twin unit constructs a virtual environment that reproduces the traffic situation around the event, using the virtual objects generated by the generative AI unit. It simulates the movement of vehicles, the control of traffic lights, and the congestion situation of roads, using a physics engine. The flow of vehicles when a specific road is congested and the effect of changing the timing of traffic lights can be tested in the virtual environment. Changes in visibility and slipperiness of the road surface due to weather conditions are also reproduced.

The simulation control unit executes a simulation using a traffic management algorithm within the virtual environment constructed by the digital twin unit. For example, to mitigate the congestion expected at the start of the event, it proposes a detour route and adjusts the timing of traffic lights. When an emergency vehicle passes, it sets a priority passage route and gives appropriate instructions to other vehicles. Based on the simulation results, it derives an optimal traffic management strategy in real time and reflects it in the actual city traffic.

A traffic control center changes the control pattern of traffic lights based on the simulation results and optimizes the flow of traffic. It provides optimal routes and traffic information to citizens through a smartphone application. This makes it possible to improve the traffic efficiency of the entire city during the event and realize the mitigation of congestion and the reduction of traffic accidents.

The specific processing unit 290 transmits a result of the specific processing to the smart device 14. In the smart device 14, the control unit 46A causes the output device 40 to output the result of the specific processing. The microphone 38B acquires voice indicating a user input for the result of the specific processing. The control unit 46A transmits voice data indicating the user input acquired by the microphone 38B to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

An example form in which the specific processing is performed by the data processing apparatus 12 has been described, but the technology of the present disclosure is not limited to this, and the specific processing may be performed by the smart device 14.

### Second Embodiment

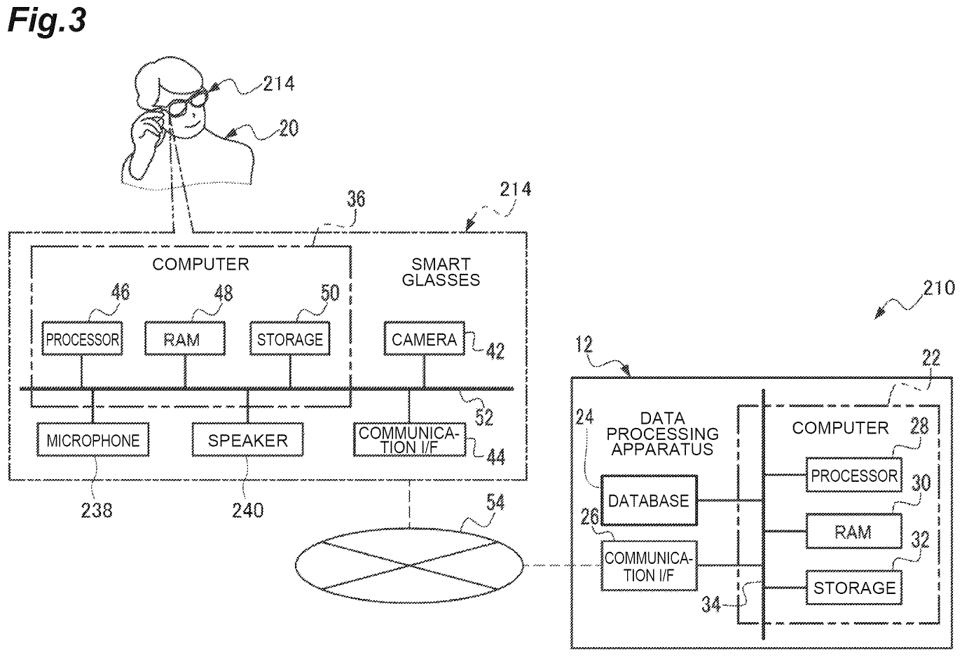

FIG. 3 illustrates an example of a configuration of a data processing system 210 according to a second embodiment.

As illustrated in FIG. 3, the data processing system 210 includes a data processing apparatus 12 and smart glasses 214. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The smart glasses 214 include a computer 36, a microphone 238, a speaker 240, a camera 42, and a communication I/F 44. The computer 36 includes a processor 46, a RAM 48, and a storage 50. The processor 46, the RAM 48, and the storage 50 are connected to a bus 52. Also, the microphone 238, the speaker 240, and the camera 42 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

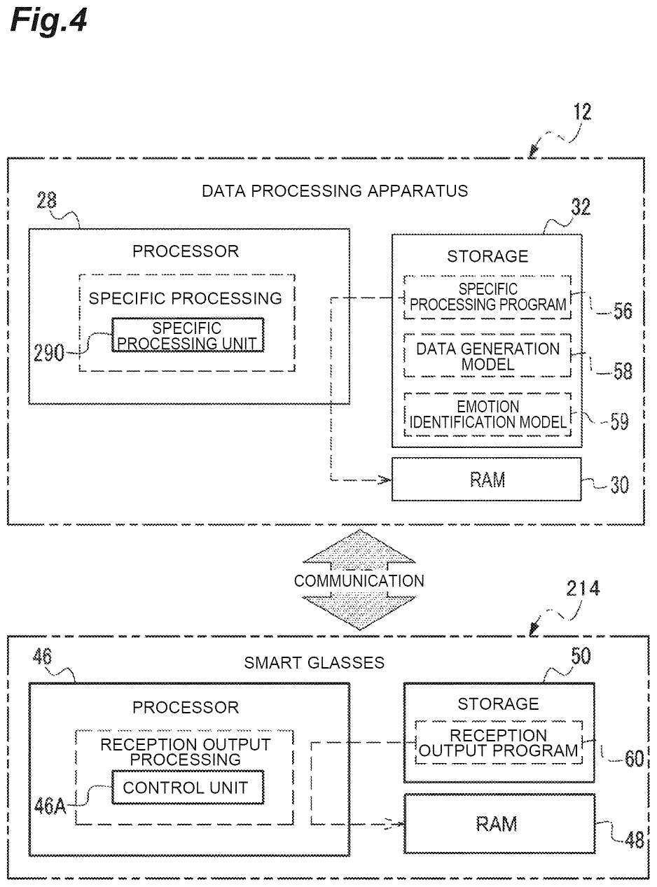

FIG. 4 illustrates an example of main functions of the data processing apparatus 12 and the smart glasses 214. As illustrated in FIG. 4, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290. The specific processing unit 290 can estimate a user's emotion using the emotion identification model 59 and perform specific processing using the user's emotion. In an emotion estimation function (emotion identification function) using the emotion identification model 59, various estimations and predictions regarding the user's emotion, including estimation and prediction of the user's emotion, are performed, but is not limited to such examples. Also, the estimation and prediction of emotion include, for example, analysis (analytics) of emotion and the like.

In the smart glasses 214, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48. Note that the smart glasses 214 may have a data generation model and an emotion identification model similar to the data generation model 58 and the emotion identification model 59, and can also perform processing similar to that of the specific processing unit 290 using these models.

Next, specific processing by the specific processing unit 290 of the data processing apparatus 12 will be described. Each unit of the system described below is realized by the data processing apparatus 12 and the smart glasses 214. In the following description, the data processing apparatus 12 is referred to as a “server”, and the smart glasses 214 are referred to as a “terminal”.

### Example 2.1

Since the flow of the specific processing is the same as that in Example 1.1 described in the first embodiment, a description thereof is omitted.

### Example 2.2

Since the flow of the specific processing is the same as that in Example 1.2 described in the first embodiment, a description thereof is omitted.

The specific processing unit 290 transmits a result of the specific processing to the smart glasses 214. In the smart glasses 214, the control unit 46A causes the speaker 240 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

An example form in which the specific processing is performed by the data processing apparatus 12 has been described, but the technology of the present disclosure is not limited to this, and the specific processing may be performed by the smart glasses 214.

### Third Embodiment

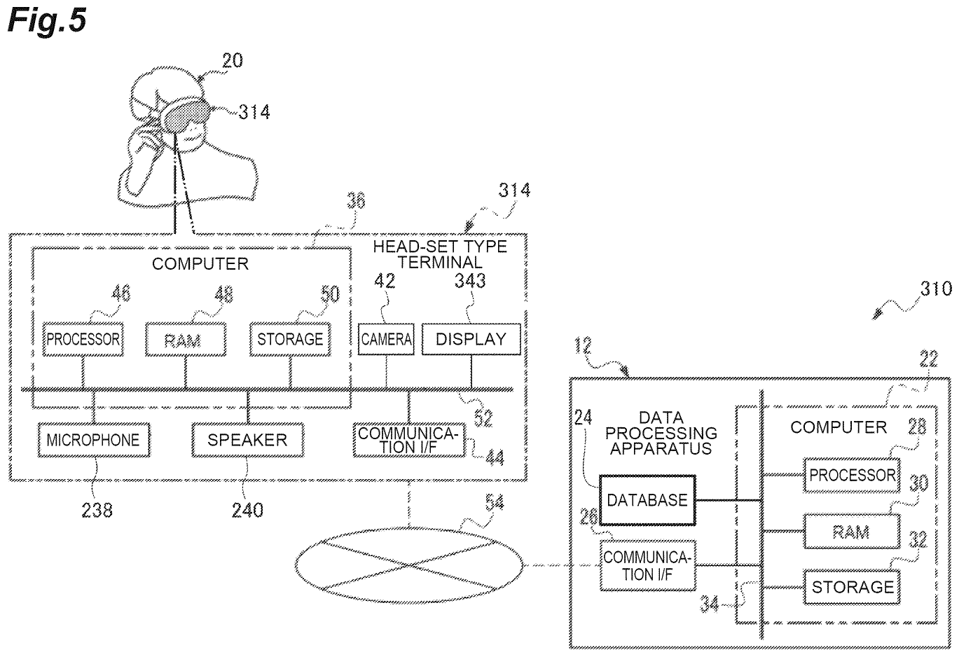

FIG. 5 illustrates an example of a configuration of a data processing system 310 according to a third embodiment.

As illustrated in FIG. 5, the data processing system 310 includes a data processing apparatus 12 and a headset-type terminal 314. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The headset-type terminal 314 includes a computer 36, a microphone 238, a speaker 240, a camera 42, a communication I/F 44, and a display 343. The computer 36 includes a processor 46, a RAM 48, and a storage 50. The processor 46, the RAM 48, and the storage 50 are connected to a bus 52. Also, the microphone 238, the speaker 240, the camera 42, and the display 343 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

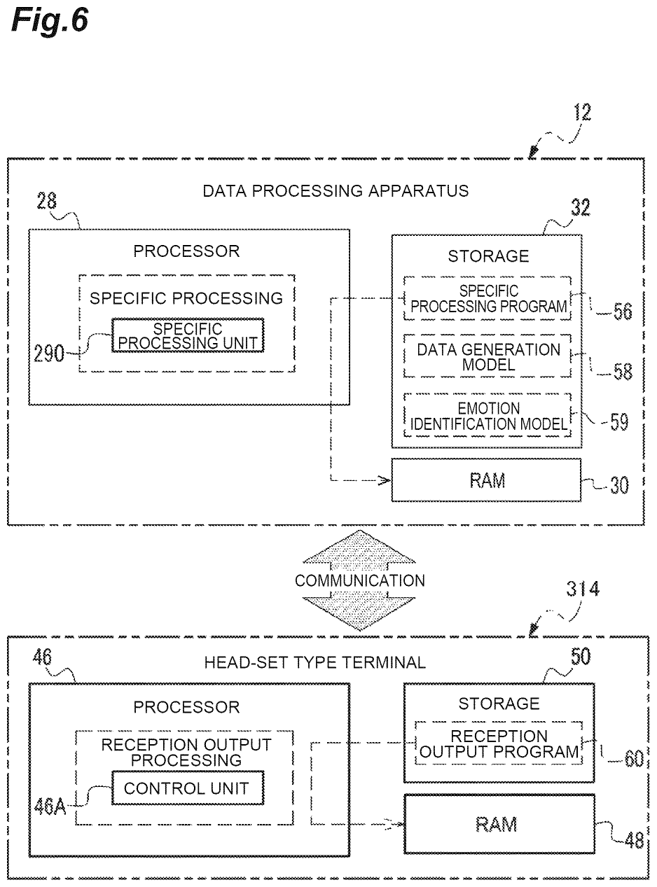

FIG. 6 illustrates an example of main functions of the data processing apparatus 12 and the headset-type terminal 314. As illustrated in FIG. 6, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290.

In the headset-type terminal 314, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48.

Next, specific processing by the specific processing unit 290 of the data processing apparatus 12 will be described. Each unit of the system described below is realized by the data processing apparatus 12 and the headset-type terminal 314. In the following description, the data processing apparatus 12 is referred to as a “server”, and the headset-type terminal 314 is referred to as a “terminal”.

### Example 3.1

Since the flow of the specific processing is the same as that in Example 1.1 described in the first embodiment, a description thereof is omitted.

### Example 3.2

Since the flow of the specific processing is the same as that in Example 1.2 described in the first embodiment, a description thereof is omitted.

The specific processing unit 290 transmits a result of the specific processing to the headset-type terminal 314. In the headset-type terminal 314, the control unit 46A causes the speaker 240 and the display 343 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

An example form in which the specific processing is performed by the data processing apparatus 12 has been described, but the technology of the present disclosure is not limited to this, and the specific processing may be performed by the headset-type terminal 314.

### Fourth Embodiment

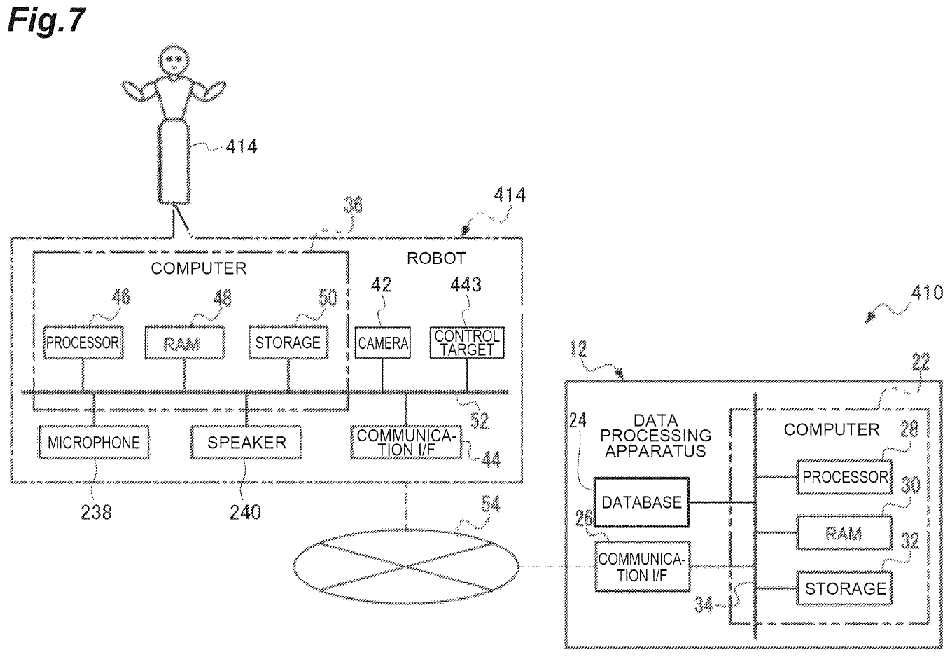

FIG. 7 illustrates an example of a configuration of a data processing system 410 according to a fourth embodiment.

As illustrated in FIG. 7, the data processing system 410 includes a data processing apparatus 12 and a robot 414. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The robot 414 includes a computer 36, a microphone 238, a speaker 240, a camera 42, a communication I/F 44, and a control target 443. The computer 36 includes a processor 46, a RAM 48, and a storage 50. The processor 46, the RAM 48, and the storage 50 are connected to a bus 52. Also, the microphone 238, the speaker 240, the camera 42, and the control target 443 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

The control target 443 includes a display device, an LED of an eye part, and motors that drive an arm, a hand, a leg, and the like. The posture and gestures of the robot 414 are controlled by controlling the motors of the arm, hand, leg, and the like. A part of the emotions of the robot 414 can be expressed by controlling these motors. Also, the facial expression of the robot 414 can also be expressed by controlling the light emission state of the LED of the eye part of the robot 414.

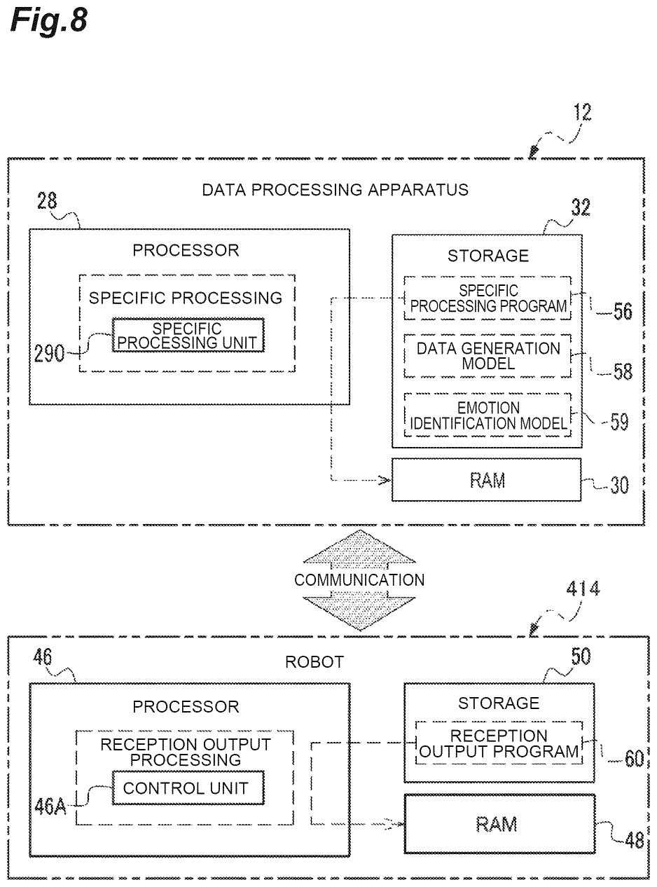

FIG. 8 illustrates an example of main functions of the data processing apparatus 12 and the robot 414. As illustrated in FIG. 8, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290.

In the robot 414, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48.

Next, specific processing by the specific processing unit 290 of the data processing apparatus 12 will be described. Each unit of the system described below is realized by the data processing apparatus 12 and the robot 414. In the following description, the data processing apparatus 12 is referred to as a “server”, and the robot 414 is referred to as a “terminal”.

### Example 4.1

Since the flow of the specific processing is the same as that in Example 1.1 described in the first embodiment, a description thereof is omitted.

### Example 4.2

Since the flow of the specific processing is the same as that in Example 1.2 described in the first embodiment, a description thereof is omitted.

The specific processing unit 290 transmits a result of the specific processing to the robot 414. In the robot 414, the control unit 46A causes the speaker 240 and the control target 443 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

An example form in which the specific processing is performed by the data processing apparatus 12 has been described, but the technology of the present disclosure is not limited to this, and the specific processing may be performed by the robot 414.

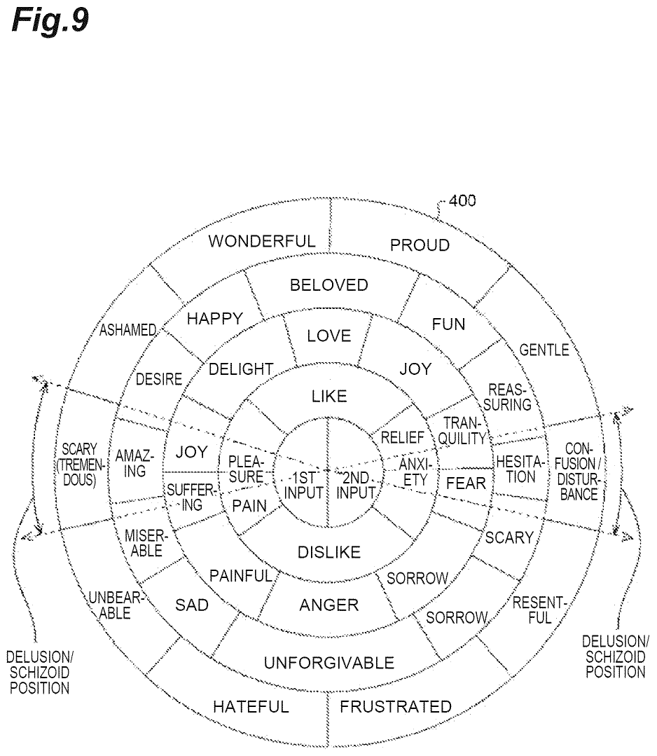

Note that the emotion identification model 59 as an emotion engine may determine a user's emotion according to a specific mapping. For example, the emotion identification model 59 may determine the user's emotion according to an emotion map (see FIG. 9), which is a specific mapping. Also, the emotion identification model 59 may similarly determine the robot's emotion, and the specific processing unit 290 may perform specific processing using the robot's emotion.

FIG. 9 is a diagram illustrating an emotion map 400 on which a plurality of emotions are mapped. In the emotion map 400, emotions are arranged in concentric circles radiating from the center. The closer to the center of the concentric circles, the more primitive the state of the emotion is arranged. On the outer side of the concentric circles, emotions representing states and actions arising from a state of mind are arranged. Emotion is a concept that also includes affect and mental states. On the left side of the concentric circles, emotions generated from reactions that generally occur in the brain are arranged. On the right side of the concentric circles, emotions that are generally induced by situational judgment are arranged. In the upward and downward directions of the concentric circles, emotions that are generated from reactions that generally occur in the brain and are induced by situational judgment are arranged. Also, on the upper side of the concentric circles, “pleasant” emotions are arranged, and on the lower side, “unpleasant” emotions are arranged. In this way, in the emotion map 400, a plurality of emotions are mapped based on the structure in which emotions are generated, and emotions that are likely to occur at the same time are mapped close to each other.

These emotions are distributed in the 3 o'clock direction of the emotion map 400, and usually go back and forth between relief and anxiety. In the right half of the emotion map 400, situational awareness is superior to internal sensations, resulting in a calm impression.

Since the inside of the emotion map 400 represents the inside of the mind and the outside of the emotion map 400 represents actions, the further one goes to the outside of the emotion map 400, the more visible (manifested in action) the emotion becomes.

Here, human emotions are based on various balances such as posture and blood sugar levels, and show a state of unpleasantness when those balances move away from the ideal, and a state of pleasantness when they approach the ideal. In robots, automobiles, motorcycles, and the like as well, emotions can be created based on various balances such as posture and remaining battery level, so as to show a state of unpleasantness when those balances move away from the ideal, and a state of pleasantness when they approach the ideal. The emotion map may be generated based on, for example, Dr. Mitsuyoshi's emotion map (Research on a speech emotion recognition and brain physiological signal analysis system of affect, Tokushima University, doctoral dissertation: https://ci.ni.ac.jp/naid/500000375379). In the left half of the emotion map, emotions belonging to a region called “reaction” where sensation is dominant are arranged. Also, in the right half of the emotion map, emotions belonging to a region called “situation” where situational awareness is dominant are arranged.

In the emotion map, two emotions that promote learning are defined. One is an emotion around the middle of negative “remorse” and “reflection” on the situation side. That is, it is when a negative emotion such as “I never want to feel this way again” or “I don't want to be scolded anymore” arises in the robot. The other is an emotion around positive “desire” on the reaction side. That is, it is when there is a positive feeling such as “I want more” or “I want to know more”.

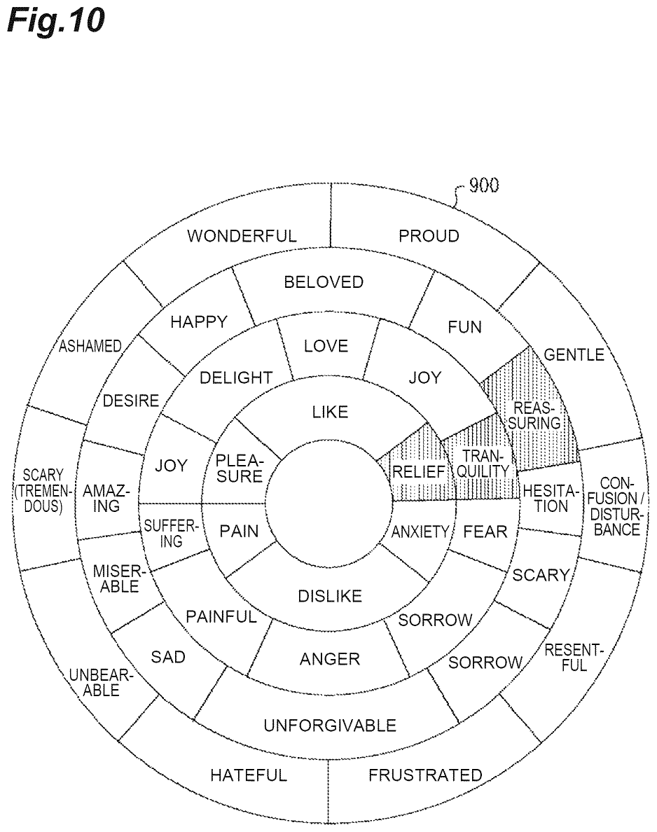

The emotion identification model 59 inputs a user input into a pre-trained neural network, acquires an emotion value indicating each emotion shown in the emotion map 400, and determines the user's emotion. This neural network is pre-trained based on a plurality of learning data that are combinations of user inputs and emotion values indicating each emotion shown in the emotion map 400. Also, this neural network is trained such that emotions arranged close to each other have close values, as in the emotion map 900 shown in FIG. 10. FIG. 10 shows an example in which a plurality of emotions, “relief,” “peace of mind,” and “reassured,” have close emotion values.

Furthermore, the aforementioned emotion identification model 59 and emotion map 400 are applied to behavior models of virtual humans (pedestrians and other drivers) in the digital twin unit. For example, when the weather in the virtual environment is “heavy rain,” an emotion parameter of a virtual pedestrian shifts to a region of “anxiety” or “impatience,” and accordingly, the virtual pedestrian is programmed such that a probability of taking an unpredictable action such as “ignoring a traffic light” or “sudden crossing” increases. In this way, by coupling the emotion model to physical action logic, it is possible to incorporate sudden traffic risks caused by human psychology, which could not be reproduced by conventional rule-based crowd simulation, into test scenarios for the autonomous driving AI.

Although the system according to the present disclosure has been described above mainly with respect to the functions of the data processing apparatus 12, the system according to the present disclosure is not necessarily implemented in a server. The system according to the present disclosure may be implemented as a general information processing system. The present disclosure may be implemented as, for example, a software program that runs on a personal computer, or an application that runs on a smartphone or the like. The method according to the present disclosure may be provided to a user in a SaaS (Software as a Service) format.

An example form in which the specific processing is performed by one computer 22 has been described, but the technology of the present disclosure is not limited to this, and distributed processing for the specific processing may be performed by a plurality of computers including the computer 22. For example, the data generation model 58 may be provided in an external device of the data processing apparatus 12, and the external device may generate data according to the input data.

An example form in which the specific processing program 56 is stored in the storage 32 has been described, but the technology of the present disclosure is not limited to this. For example, the specific processing program 56 may be stored in a portable computer-readable non-transitory storage medium such as a USB (Universal Serial Bus) memory. The specific processing program 56 stored in the non-transitory storage medium is installed in the computer 22 of the data processing apparatus 12. The processor 28 executes the specific processing according to the specific processing program 56.

Also, the specific processing program 56 may be stored in a storage device such as a server connected to the data processing apparatus 12 via the network 54, and the specific processing program 56 may be downloaded in response to a request from the data processing apparatus 12 and installed in the computer 22.

Note that it is not necessary to store all of the specific processing program 56 in a storage device such as a server connected to the data processing apparatus 12 via the network 54, or to store all of the specific processing program 56 in the storage 32, and a part of the specific processing program 56 may be stored.

As hardware resources for executing the specific processing, various processors shown below can be used. Examples of the processor include a CPU, which is a general-purpose processor that functions as a hardware resource for executing the specific processing by executing software, that is, a program. Also, examples of the processor include a dedicated electric circuit, which is a processor having a circuit configuration specifically designed to execute specific processing, such as an FPGA (Field-Programmable Gate Array), a PLD (Programmable Logic Device), or an ASIC (Application Specific Integrated Circuit). A memory is built in or connected to any of the processors, and any of the processors executes the specific processing by using the memory.

The hardware resource that executes the specific processing may be configured by one of these various processors, or may be configured by a combination of two or more processors of the same type or different types (for example, a combination of a plurality of FPGAs, or a combination of a CPU and an FPGA). Also, the hardware resource that executes the specific processing may be one processor.

As an example of a configuration with one processor, first, there is a form in which one processor is configured by a combination of one or more CPUs and software, and this processor functions as a hardware resource for executing the specific processing. Second, there is a form in which a processor that realizes the functions of an entire system including a plurality of hardware resources for executing the specific processing with one IC chip, as represented by an SoC (System-on-a-chip) or the like, is used. In this way, the specific processing is realized using one or more of the various processors described above as hardware resources.

Furthermore, as a hardware structure of these various processors, an electric circuit in which circuit elements such as semiconductor elements are combined can be used. Also, the specific processing described above is merely an example. Therefore, it goes without saying that unnecessary steps may be deleted, new steps may be added, or the processing order may be changed within a scope that does not depart from the gist.

The description and illustrations shown above are detailed descriptions of the parts related to the technology of the present disclosure, and are merely an example of the technology of the present disclosure. For example, the description regarding the above-described configuration, function, operation, and effect is a description regarding an example of the configuration, function, operation, and effect of the part related to the technology of the present disclosure. Therefore, it goes without saying that unnecessary parts may be deleted, new elements may be added, or replacements may be made to the description and illustrations shown above within a scope that does not depart from the gist of the technology of the present disclosure. Also, in order to avoid confusion and facilitate understanding of the parts related to the technology of the present disclosure, in the description and illustrations shown above, descriptions regarding common general technical knowledge and the like that do not require particular explanation for enabling the implementation of the technology of the present disclosure are omitted.

All documents, patent applications, and technical standards described in this specification are incorporated herein by reference to the same extent as if each individual document, patent application, and technical standard were specifically and individually indicated to be incorporated by reference.

It is to be understood that not all aspects, advantages and features described herein may necessarily be achieved by, or included in, any one particular example. Indeed, having described and illustrated various examples herein, it should be apparent that other examples may be modified in arrangement and detail.

A system comprising a generative AI unit, a digital twin unit, and a simulation control unit. The generative AI unit analyzes real-time data acquired from traffic sensors, surveillance cameras, and GPS devices within a city, analyzes instructions and reports related to traffic using natural language processing technology and computer vision technology, and recognizes the flow of vehicles and the movement of pedestrians. The digital twin unit constructs a virtual environment that reproduces the traffic situation of the entire city using virtual objects generated by the generative AI unit, and simulates the movement of vehicles, the control of traffic lights, and the congestion situation of roads using a physics engine. The simulation control unit executes a simulation using a traffic management algorithm within the virtual environment constructed by the digital twin unit, derives an optimal traffic management strategy in real time, and reflects it in the actual city traffic.

In some examples, the generative AI unit is provided with a function of proposing a detour route when a specific road is congested, using data from traffic sensors. Furthermore, it can analyze images from surveillance cameras and test the effect of changing the timing of traffic lights in a virtual environment. This makes it possible to set a priority passage route and give appropriate instructions to other vehicles when an emergency vehicle passes.

In some examples, the digital twin unit is provided with a function of simulating the acceleration, braking, and behavior at the time of a collision of a vehicle, using a physics engine. Furthermore, it can reproduce changes in visibility and slipperiness of the road surface due to weather conditions, and the road layout and traffic signal arrangement of an urban area are also reproduced in the virtual environment. This makes it possible for the simulation control unit to record the behavior of the autonomous driving AI in detail for each scenario and generate data for evaluating performance.

An example system for evaluating the performance of an autonomous driving AI may include circuitry. The circuitry may be configured to: generate a virtual object by analyzing input natural language data and video data using natural language processing technology and computer vision technology; construct a virtual environment that reproduces physical characteristics and behavior of a real world based on the virtual object; execute a simulation under a plurality of scenarios using the autonomous driving AI in the virtual environment; and evaluate the performance of the autonomous driving AI for each of the plurality of scenarios.

In some examples, the circuitry may be configured to: extract a keyword related to a scenario from input text data using the natural language processing technology; and set a parameter of the virtual environment based on the keyword.

In some examples, the circuitry may be configured to: recognize a movement of a vehicle, a behavior of a human, and a state of a traffic light from input video data using the computer vision technology; and reflect the information in the virtual environment.

In some examples, the circuitry may be configured to simulate a behavior of the virtual object based on physical laws of the real world using a physics engine.

In some examples, simulating the behavior of the virtual object based on physical laws of the real world may include reproducing acceleration, braking, and behavior at a time of collision of a virtual vehicle, a change in visibility due to a virtual weather condition, and slipperiness of a virtual road surface. The virtual vehicle, the virtual weather condition, and the virtual road surface may constitute the virtual object.

Evaluating the performance of the autonomous driving AI for each of the plurality of scenarios may include evaluating the performance of the autonomous driving AI based on whether a behavior of the autonomous driving AI causes the virtual vehicle to operate safely for each of the plurality of scenarios.

An example method of evaluating the performance of an autonomous driving AI may include: analyzing input natural language data and video data using natural language processing technology and computer vision technology to generate a virtual object including a virtual vehicle, a virtual human, virtual weather, and a virtual road surface; constructing a virtual environment that reproduces physical characteristics and behavior of a real world based on the virtual object; executing a simulation under a plurality of scenarios using the autonomous driving AI in the virtual environment; and evaluating the performance of the autonomous driving AI for each of the plurality of scenarios.

What is claimed is:

1. A system for evaluating performance of an autonomous driving AI, the system comprising circuitry,
wherein the circuitry is configured to:
generate a virtual object by analyzing input natural language data and video data using natural language processing technology and computer vision technology;
construct a virtual environment that reproduces physical characteristics and behavior of a real world based on the virtual object;
execute a simulation under a plurality of scenarios using the autonomous driving AI in the virtual environment; and
evaluate the performance of the autonomous driving AI for each of the plurality of scenarios.

2. The system according to claim 1, wherein the circuitry is configured to:
extract a keyword related to a scenario from input text data using natural language processing technology; and
set a parameter of the virtual environment based the keyword.

3. The system according to claim 1, wherein the circuitry is configured to:
recognize a movement of vehicle, a behavior of a human, and a state of a traffic light from input video data using the computer vision technology; and
reflect the information in the virtual environment.

4. The system according to claim 1, wherein the circuitry is configured to simulate a behavior of the virtual object based on the physical laws of the real world using a physics engine.

5. The system according to claim 4,
wherein simulating the behavior of the virtual object based on the physical laws of the real world includes reproducing the acceleration, braking, and behavior at a time of collision of a virtual vehicle, a change in visibility due to a virtual weather condition, and slipperiness of a virtual road surface, and
wherein the virtual vehicle, the virtual weather condition, and the virtual road surface constitute the virtual object.

6. The system according to claim 5, wherein evaluating the performance of the autonomous driving AI for each of the plurality of scenarios includes evaluating the performance of the autonomous driving AI based on whether a behavior of the autonomous driving AI causes the virtual vehicle to operate safely for each of the plurality of scenarios.

7. A method of evaluating performance of an autonomous driving AI, the method comprising:
analyzing input natural language data and video data using natural language processing technology and computer vision technology to generate a virtual object including a virtual vehicle, a virtual human, virtual weather, and a virtual road surface;
constructing a virtual environment that reproduces physical characteristics and behavior of a real world based on the virtual object;
executing a simulation under a plurality of scenarios using the autonomous driving AI in the virtual environment; and
evaluating the performance of the autonomous driving AI for each of the plurality of scenarios.
